(19) United States
(12) Patent Application Publication
(10) Pub. No.: US 2002/0096542 A1
(43) Pub. Date: Jul. 25, 2002

(54) Measuring and dispensing lid

(76) Inventors: Layna Marie Crofts, Corona, CA (US); Jeremy Paul Sanders, Corona, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 10/029,690

(22) Filed: Dec. 20, 2001

Related U.S. Application Data
(60) Provisional application No. 60/258,227, filed on Dec. 27, 2000.

(51) Int. Cl. B67D 5/06

(52) U.S. Cl. 222/504

(57) ABSTRACT

A dispensing device comprises an upper surface having a sidewall depending generally vertically from a periphery thereof, a neck extending generally perpendicular from said upper surface in a direction opposite that of said sidewall, and a measuring reservoir, having a proximal and dispensing opening, attached to said neck. The upper surface tapers eccentrically from the sidewall and extends to a periphery of the neck to direct product to pour through the neck and into the measuring reservoir. The sidewall has an annular ridge extending inward for allowing the device to securely mount to a container of product. The measuring reservoir may have at least one louver for selectively and substantially covering the dispensing opening, and is user actuatable between an open and closed position.

### RELATED APPLICATION

This invention claims priority from U.S. Provisional Application Serial No. 60/258,227 filed on Dec. 27, 2000, the entire disclosure of which is hereby incorporated by reference.

### BACKGROUND OF THE INVENTION

1. Field of the Invention

The present invention relates generally to dispensing of products such as liquids, powders, or small particulate substances that require an accurate and repeatable measurement to be delivered to another container or medium. Specifically, the measuring and dispensing mechanism is integrated into a lid that is attachable to the container holding the product to be measured and dispensed.

2. Description of the Related Art

Currently, there are many applications in which an accurate measurement of product must be dispensed including automotive oil or fuel additive, laundry detergent, baby formula, powdered drink mixes, and the like. At least one preferred embodiment is directed at measuring and dispensing baby formula, thus the remainder of this disclosure will focus on that embodiment without departing from the broader scope of the invention as claimed, and should not be construed as a limitation. Currently, baby formula manufacturers provide a generally flat plastic lid that fits over the top of a cylindrical can holding the powdery formula. A small measuring scoop with a handle extending therefrom is included inside the can. The scoop is used to deliver a predetermined amount of formula powder into a bottle containing a known quantity of water. Generally, one scoop of powder is added to two ounces of water. With this known ratio, the user can then add the correct number of scoops of formula dependent upon the known volume of water in the bottle.

This conventional means of measuring and delivering formula powder to a bottle poses several difficulties and drawbacks. First of which is the initial retrieval of the measuring scoop. Because product contents shift during transport, oftentimes the scoop is not located at the top of the can and requires the user to dig through the formula to locate it. This is often a messy process which results in spilled formula, powder sticking to wet or oily fingers, and contaminants entering the formula. Additionally, with each subsequent retrieval of the scoop, the user invariably gets powder on their fingers when retrieving the scoop which is messy and introduces additional contaminants from the user's fingers into the formula.

Further problems result when trying to make a bottle using only one hand, such as when holding a baby in one arm. As the user tries to pour the powder from the measuring scoop into a bottle, formula is spilled because the scoop diameter is almost equivalent to that of the bottle, and the scoop usually has vertical sides. As the scoop is held adjacent to the bottle opening and is then quickly turned upside-down, the powder is dispensed before the scoop can be adequately positioned directly above the bottle which results in some quantity of powder being spilled onto the work surface. Not only does this cause a mess requiring clean-up time, but the formula is very expensive and even a small amount of waste can add to substantial losses throughout a baby's bottle stage.

The conventional scoop also requires removal of the can's lid every time a user makes a bottle. This provides an increased risk of spilling the powder, especially when attempting to remove it one-handed. Additionally, contaminants are free to enter the can whenever the lid is removed.

The traditional scoop additionally causes contaminants to enter the can of formula. Because the scoop must be removed from the can, not only do contaminants get on the scoop handle from a user's dirty fingers, it is also possible to lay the scoop down on a dirty work surface before returning it to the can, thus introducing a number of contaminants found on people's hands and on a counter work surface directly into the formula can.

Finally, it is nearly impossible for the scoop to completely empty the can of formula. This results from the difference in radii of the scoop and the can. The formula settles in the bottom of the can and even when tipping the can to cause the contents to shift to the edge of the bottom of the can, the scoop is unable to adequately fit into the corner formed by the circular bottom of the can abutting the circumferential side.

What is needed is an easy and clean way to dispense the proper amount of baby formula into a bottle utilizing one hand that allows the formula container to remain closed to prevent contamination, prevents the user from getting powder on their fingers, and reduces waste of the expensive formula by reducing spillage and allows use of the entire contents of the can of formula. These and other advantages will become readily apparent to one of ordinary skill in the art in accordance with the following drawings and detailed description.

### SUMMARY OF THE INVENTION

The measuring and dispensing lid disclosed herein advantageously provides a solution to the above-mentioned problems by providing a new measuring and delivery system that offers a clean, simple way of dispensing baby formula into a bottle with only one hand, while allowing the formula container to remain closed thus reducing contaminants, avoiding spillage, and eliminating formula from getting on the user's fingers.

In one aspect, there is provided a new lid comprising an integral measuring reservoir and delivery system whereby a user initially opens the can of formula, usually a metal lid with a pull top, attaches the disclosed lid to the top thereof, and only needs to remove the lid once can contents are emptied.

In one embodiment, the measuring and dispensing device is formed integrally with the snap on lid and is either in constant communication with the interior of the can, or may be selectively closed off from the interior of the can. Additionally, the dispensing end of the device may be initially closed off and may be selectively opened by the user once the powder is accurately measured and the device is positioned properly with respect to the bottle opening such that little or no formula is allowed to spill onto the work surface.

The following drawings and descriptions thereof shall make the preferred, and additional embodiments, clear to one of ordinary skill in the art.

### BRIEF DESCRIPTION OF THE DRAWINGS

FIG. 1 illustrates a side view of one embodiment and orientation of a measuring reservoir integrated into the lid.

FIG. 2 illustrates a side view of another embodiment and orientation of a measuring reservoir integrated into the lid.

FIG. 3 illustrates a closing mechanism.

FIG. 4 illustrates another closing mechanism.

FIG. 5 illustrates yet another closing mechanism.

FIG. 6 illustrates one embodiment of an actuator for a closing mechanism.

### DETAILED DESCRIPTION OF PREFERRED EMBODIMENTS

The following description will describe several preferred embodiments where like reference numerals designate like parts throughout.

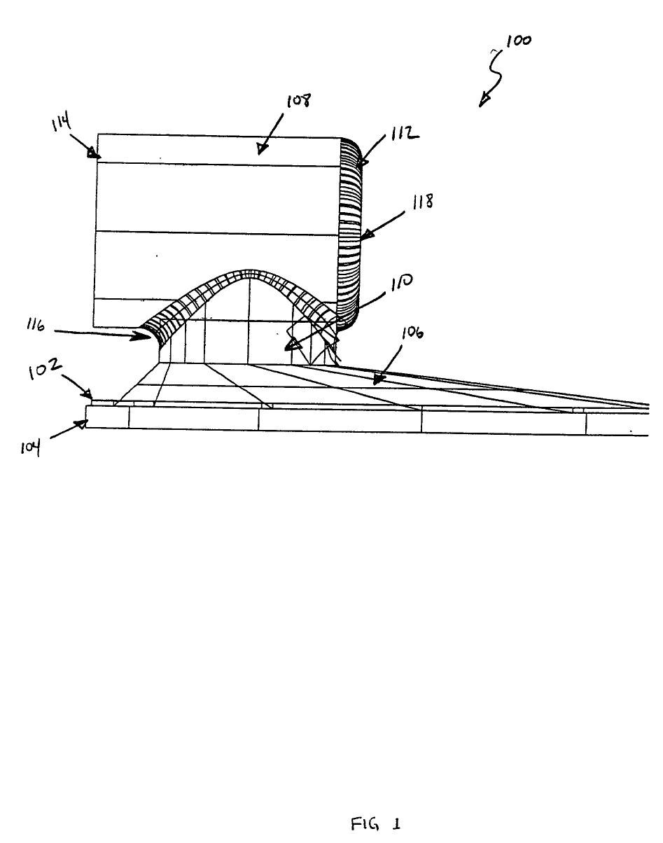

In the figures, FIG. 1 illustrates one embodiment of a measuring and dispensing lid (“lid”) 100. The lid is formed of a suitable material such as plastic, is preferably semi transparent, and may be formed as a single piece. The rim 102 has a sidewall 104 depending vertically therefrom for securely attaching the lid to a container of material (not shown) as in generally known in the art. The upper surface of the lid 106 is formed as an eccentric frustroconical shape such that when the container of material with the attached device 100 is inverted, the material is directed into the measuring reservoir 108. The measuring reservoir 108 has a neck 110 that connects it to the upper surface of the lid 106 and provides fluid communication therewith. The measuring reservoir 108 preferably is configured to hold a predetermined volume which may be in the range of from about 1 ml to 500 ml, and more preferably between about 14 ml and 60 ml, and in one embodiment, about 30 mL, although volumes outside of this range are possible depending on the application. The measuring reservoir 108 is closed at a proximal end 112 and open at a dispensing end 114. The dispensing end 114 may contain a cover or closure that can be manipulated by the user for convenience, as will be discussed in greater detail below. The radiused rest 116 caused by the joinder of the measuring reservoir 108 to the neck 110 provides a guide and resting place for the container into which the material is being dispensed.

As illustration, and not as a limitation, the device will be described as attached to a can of concentrated baby formula powder. The lid 100 is first attached to an open can of formula. The can and device are then inverted which causes formula to enter the measuring reservoir 108. It can be seen how the shape of the upper surface of the lid 106 is able to direct the powder into the measuring reservoir 108; however, specific dimensions are not important.

The measuring reservoir 108 may be offset from the center of the lid for ease in dispensing, hence the eccentricity of the upper surface of the lid 106. Once the inverted measuring reservoir 108 is filled to capacity, a bottle is place around and adjacent to the dispensing end 114 of the measuring reservoir 108. The measuring reservoir 108 is configured with a diameter less than the diameter of a baby's bottle such that the dispensing end 114 will fit within the opening of a baby's bottle.

The can and device are then rotated ninety degrees such that the dispensing end 114 is vertical and open to the empty bottle, at which time the formula is dispensed into the bottle. A small hole 118 may be formed into the closed proximal end 112 to avoid any air pressure differential effects to encourage the formula to exit the dispensing end 114 of the measuring reservoir 108.

Because of the consistency of the powder, it does not maintain a 45-degree sidewall angle like many other small particulate matter. For example, when pouring dry sand into a pile, it will usually form a cone with a substantially 45-degree sidewall angle. Baby formula is “sticky”, especially when packed into a measuring reservoir, and will maintain a much steeper sidewall angle. Because of this property of baby formula, when the can of formula with attached lid is inverted to fill the measuring reservoir 108, the powder will not have a tendency to pour out of the dispensing end 114 of the measuring reservoir 108 even if left open. For this reason, some embodiments do not require the dispensing end 114 and/or the proximal end 112 to be closed while filling the reservoir 108. Alternatively, a closure can be added to the dispensing end 114 and will be described in later detail.

Finally, when the can with attached lid are rotated to dispense the contents in the measuring reservoir 108, additional formula from the can will not flow into the measuring reservoir 108. The can with attached lid 100 are then rotated back to inverted to again fill the measuring reservoir 108 and then rotated to dispense the contents into the bottle. The process is repeated until the proper amount of formula has been dispensed into the bottle.

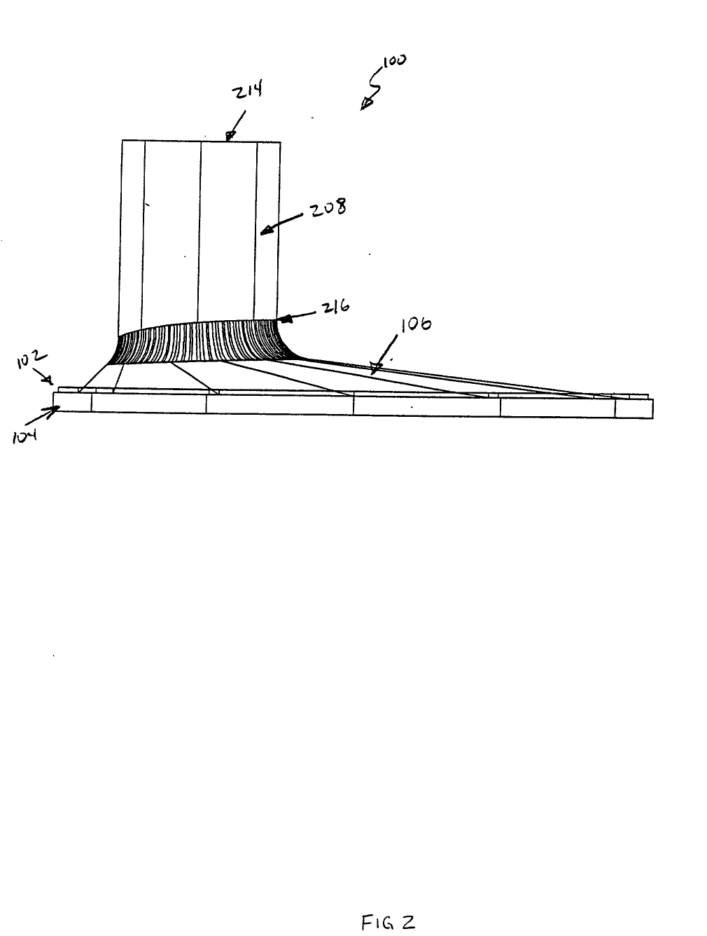

FIG. 2 illustrates another embodiment of a measuring and dispensing lid with the measuring reservoir 208 at a different orientation. In this embodiment, the rim 102 has a sidewall 104 depending therefrom as is known in the art for securing a plastic lid to a can or other container.

In this embodiment, a cover initially closes the dispensing end 214 such that formula cannot escape when the measuring reservoir 208 is being filled. The can with attached lid 100 is inverted so the measuring reservoir 208 is filled with formula. The proximal end 216 of the measuring reservoir 208 is then closed off, following which, the dispensing end 214 of the measuring reservoir 208 is opened and the contents of the reservoir are dispensed into the bottle. The dispensing end 214 is then closed off and the proximal end 216 is uncovered again and the formula is allowed to fill the measuring reservoir 208. The process is repeated until the proper amount of formula is dispensed into the bottle. The process of covering and uncovering the openings in the measuring dispenser 208 is anticipated to be a manual process; however, it is conceivable that a battery could be attached to activate a small motor to open and close the apertures upon user activation. It is anticipated that the measuring reservoir could be configured at other angles besides vertical and horizontal without departing from the scope herein.

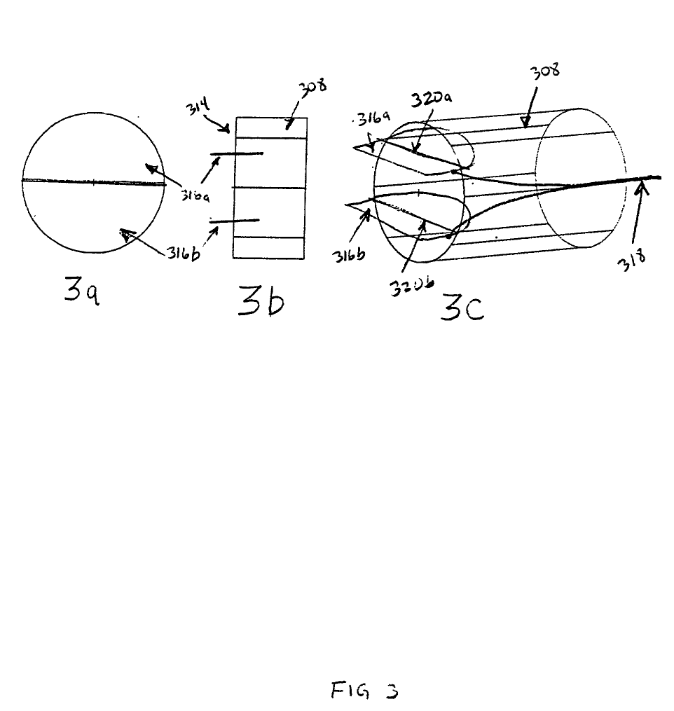

FIG. 3 illustrates one embodiment of a closure for the dispensing end 314 of the measuring reservoir 308 comprising a plurality of louvers. Two semi-circular covers 316a and 316b, or louvers, initially cover the dispensing end 314 of the dispensing reservoir 308. Upon manual actuation by a push rod 318, the louvers are caused to pivot about a hinge line 320 which opens the dispensing end 314 and allows the contents of the measuring reservoir 308 to be dispensed into the awaiting container. The semi-circular covers 316a and 316b may initially be biased in a closed position as in FIG. 3a, and require user manipulation to be opened. Upon the release of a user-supplied external force, the louvers can be resiliently returned to their closed position. The resilient force may come from a spring, cam, compliant mechanism, or other suitable mechanism as known in the art.

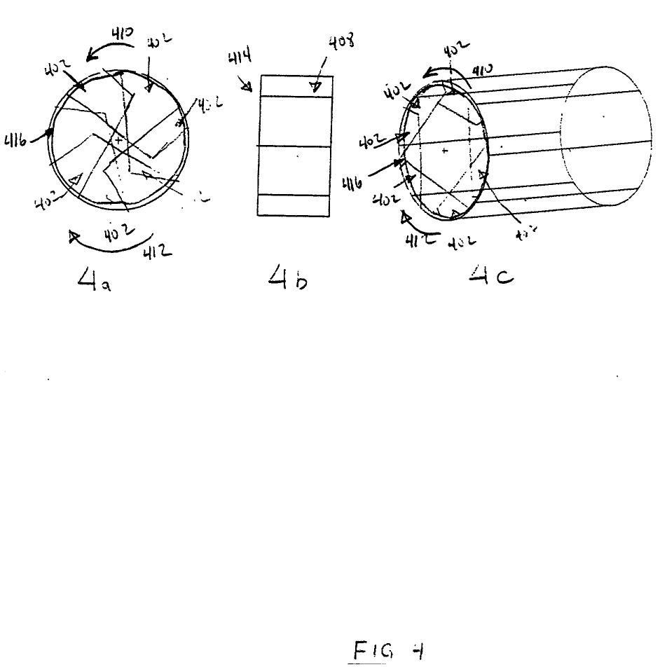

FIG. 4 depicts another embodiment of a closing mechanism for the dispensing end 414 of the measuring reservoir 408. This embodiment resembles a camera shutter in which a plurality of small covers 402 are rotatably disposed relative to one another and come together to form a closed cover. FIG. 4a shows the device in a substantially closed position with the small covers 402 combining to effectively close the dispensing end of the device 414. FIG. 4c depicts the small covers 402 retracted to substantially open the dispensing end 414. The mechanism may be controlled by a rotational motion 410 of a rim 416 to retract and open the dispensing end, and likewise by another rotational motion 412 of a rim 416 to extend the small covers 402 and close the dispensing end.

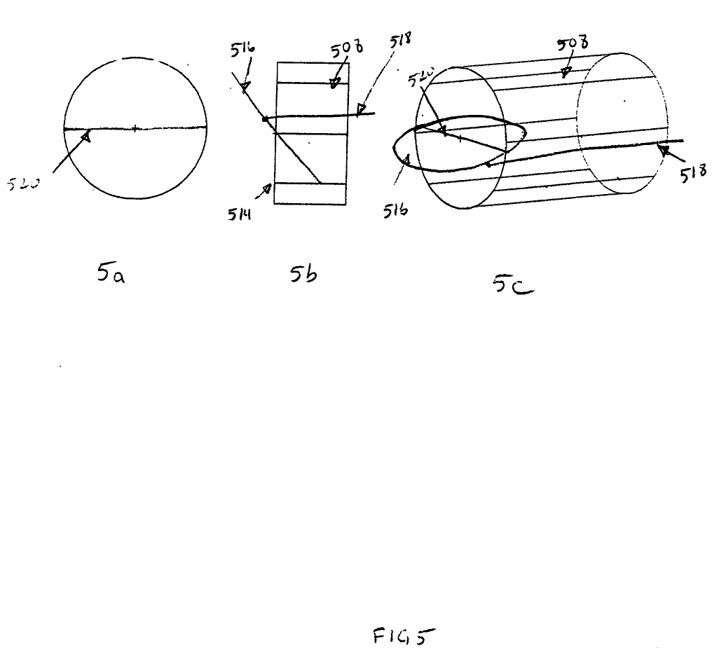

FIG. 5 depicts yet another embodiment of a closing mechanism for the dispensing end of a measuring reservoir 508. In one aspect, a single circular cover 516, or louver, pivots about a hinge line 520 to open and close the dispensing end 514. The dispensing end 514 is initially closed by the circular cover 516. The measuring reservoir 508 is filled and then positioned over the container to receive the contents. The circular cover 516 is rotated by a force applied to a push rod 518 that forces the circular cover 516 to rotate about line 520 and open the dispensing end 514 which allows the contents to dispense. It should be appreciated that the push rod 518 can be connected close to or far away from the hinge line 520, which directly controls the amount of linear motion required to fully actuate the circular cover 516. It should also be appreciated that depending on where the push rod 518 is attached to the circular cover 520, a pulling force may either open or close the circular cover 516. In FIG. 5, a pushing force opens the dispensing end while a pulling force closes the dispensing end. An annular ridge (not shown) or small protrusion (not shown) within the dispensing end 514 precludes the circular cover from rotating more than ninety degrees.

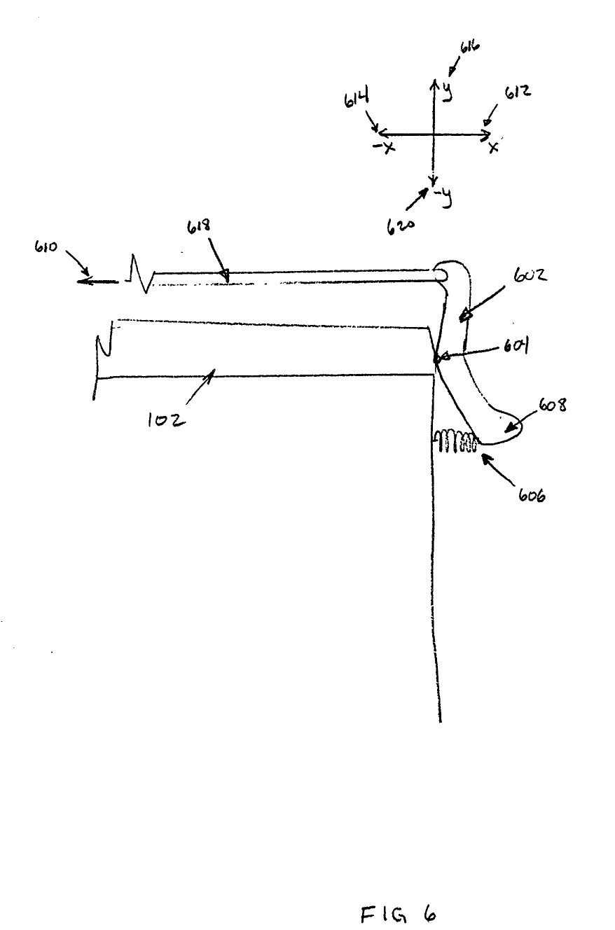

FIG. 6 depicts one method of supplying a force to rotatably open and close the covers of previous FIGS. 3 and 5. The push rod 618 is attached to an upper portion of rocker arm 602. The rocker arm 602 is pivotally connected to the lid rim 102 at 604. A biasing means 606 exerts a force on the rocker arm lower portion 608 to force it away from the can the lid is attached to. This exerted force causes the push rod 618 to exert a force 610 in the −x direction 614 on the closing mechanism (not shown) that biases the closing mechanism into its closed position. When a user supplies an external force to the rocker arm lower portion 608 to overcome the biasing force of the biasing means 606, the rocker arm upper portion 602 moves away from the lid in the x direction 612 which, in turn, causes the push rod 618 to move linearly in the x direction 612 such that an opening force is applied to the closing means. When the user releases the force on the rocker arm lower portion 608, the biasing means 606 causes the closing mechanism to return to its closed position. The push rod 618 is preferably constructed of a rigid material such that any applied forces overcome friction in the system and cause a linear motion of the push rod rather than deflect the push rod 618 in the y or −y directions 616 and 620 respectively. To reduce the rigidity of the push rod 618, it should be understood that the push rod may be supported along its length to reduce the unsupported span of the push rod 618 thereby reducing its tendency to deflect. It should also be noted that the biasing means 606 is shown as a spring under compression that returns the rocker arm and attached push rod to its initial position. However, there are numerous methods of performing this same function without the use of a spring that do not depart from the scope hereof. For example, the rocker arm could be a single-piece compliant mechanism. Furthermore, the spring could be connected above pivot point 605 such that it is in tension when the user supplies the opening force to the rocker arm lower portion 608. Finally, a spring could be mounted coaxial with the push rod 618 and compressed between cooperating stops, one located on the push rod 618, the other mounted to the rim 102. In addition to manual activation, the opening and closing mechanism could conceivably be a battery operated motor that supplies the required forces to open and close the mechanism. This motor could be activated by a user-controlled push button.

While the foregoing description illustrates several embodiments, it should be obvious to one of ordinary skill in the art that there are several ways of practicing the invention that are not disclosed herein and yet do not depart from the scope of the following claims. For example, there may be numerous undisclosed methods for closing the end of a circular opening while maintaining the closing structure within the perimeter of the circular opening. Additionally, the measuring reservoir may be oriented at any angle with respect to the lid without departing from the scope of the present invention. Therefore, the present invention should be construed according to the following claims and use the foregoing description as illustrative and not limiting.

What is claimed is:

1. A lid apparatus mounted to a container, comprising a reservoir, said reservoir having a proximal and distal opening, wherein said reservoir is in communication with said container via said proximal opening.

2. The lid apparatus according to claim 14, wherein at least one of said proximal and distal ends may be selectively opened and closed.

3. A lid comprising:
an upper surface having a sidewall depending from the periphery thereof and configured to be attachable to a source of product;
a measuring reservoir coupled to said upper surface, said measuring reservoir having a proximal inlet end and a distal dispensing end.

4. The lid according to claim 3, wherein said upper surface is shaped to taper from a first diameter at its periphery to a second diameter, such that said diameters are not coplanar.

5. The lid according to claim 4, wherein said measuring reservoir is connected to said upper surface at said second diameter, the second diameter providing an opening for said proximal inlet end.

6. The lid according to claim 3, wherein said measuring reservoir is configured to have a known volume corresponding to a standard measurement of said product.

7. The lid according to claim 6, wherein said standard measurement is about 30 mL.

8. The lid according to claim 3, further comprising a cover for selectively covering said proximal inlet end.

9. The lid according to claim 3, further comprising a cover for selectively covering said distal dispensing end.

10. The lid according to claim 9, wherein said cover is manually operable between a first closed position, and a second open position.

11. The lid according to claim 10, wherein said cover comprises at least one louver hingedly connected to said measuring reservoir.

12. The lid according to claim 11, wherein said cover is biased in a closed position.

13. The lid according to claim 11, further comprising a push rod having a first end attached to an edge of said louver, such that a linear movement of said push rod causes a rotational movement of said louver.

14. The lid according to claim 13, further comprising a rocker arm attached to a second end of said push rod, and moveable between a first and second position, wherein moving said rocker arm from said first to said second position produces a linear movement of said push rod.

15. The lid according to claim 9, wherein said cover is actuated by an electric motor.

16. A dispensing lid, wherein said lid comprises a measuring reservoir.

17. The dispensing lid as in claim 16, further comprising a dispensing opening formed in a distal end of said measuring reservoir.

18. The dispensing lid as in claim 17, further comprising a cover for selectively opening and closing said dispensing opening.

19. The dispensing lid as in claim 16, further comprising a filling aperture formed in a proximal end of said reservoir.

20. The dispensing lid as in claim 19, further comprising a cover for selectively opening and closing said filling aperture.

21. The container as in claim 16, wherein said reservoir is in fluid communication with an interior of a container.

22. The container as in claim 16, wherein said reservoir has graduated markings thereon.
